(19) United States
(12) Patent Application Publication
(10) Pub. No.: US 2026/0289018 A1
(43) Pub. Date: Sep. 24, 2026

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventor: Kohei KAIBARA, Kanagawa (JP)

(73) Assignee: FUJIFILM Business Innovation Corp., Tokyo (JP)

(21) Appl. No.: 19/280,884

(22) Filed: Jul. 25, 2025

(30) Foreign Application Priority Data
Mar. 24, 2025 (JP) 2025-048104

(51) Int. Cl. G06F 21/62; G06F 21/44

(52) U.S. Cl. CPC G06F 21/629; G06F 21/44

(57) ABSTRACT

An information processing system includes a processor configured to: receive from an information terminal of a company different from a manufacturing company of an information processing apparatus, coordination information including authentication information to be used for authentication and an authentication method of a cloud service that the company provides to a user of the information processing apparatus in cooperation with the information processing apparatus; on a storage that pre-stores on a per authentication method basis of the cloud service an authentication application corresponding to the authentication method of the cloud service, start up an authentication application corresponding to an authentication method of a cloud service selected by the user from among the cloud services having received the coordination information; and by using the authentication application corresponding to the authentication method of the selected cloud service and the coordination information on the selected cloud service, perform control such that the information processing apparatus executes the cloud service.

### CROSS-REFERENCE TO RELATED APPLICATIONS

This application is based on and claims priority under 35 USC 119 from Japanese Patent Application No. 2025-048104 filed Mar. 24, 2025.

### BACKGROUND

### (i) Technical Field

The present disclosure relates to an information processing system, a non-transitory computer readable medium, and an information processing method.

### (ii) Related Art

Japanese Unexamined Patent Application Publication No. 2020-87197 discloses an information processing system including a component setting receiving unit and an authorization service unit. The component setting receiving unit receives registration of an external service coordination information serving as information used to coordinate with an external service and the authorization service unit acquires a token from the external service using the external service coordination information and an external service coordination component that manages the external service coordination information.

Sales company selling information processing apparatuses may sell, for sales promotion, an information processing apparatus that is configured to enable users to use a cloud service provided by the sales company.

The sales company may newly produce a coordination application used to coordinate the information processing apparatus with the cloud service. However, lot of time and cost may be used to produce the coordination application.

In one contemplated method, the sales company may request a manufacturing company of information processing apparatuses to develop and load a coordination app (application) on the information processing apparatus. However, the manufacturing company has its own development schedule and typically has difficulty developing the coordination app in accordance with a schedule requested by the sales company. Specifically, when the manufacturing company of the information processing apparatus develops an app coordinating with a cloud service provided by the sales company, the manufacturing company has typically difficulty producing the coordination app in convenience with a user who uses the cloud service of the sales company.

### SUMMARY

Aspects of non-limiting embodiments of the present disclosure relate to an information processing system, non-transitory computer readable medium, and information processing method that are able to execute a cloud service of a company which a user has selected on an information processing apparatus, without newly producing a coordination app that is used when the cloud service provided by the company is used on the information processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: receive from an information terminal of a company different from a manufacturing company of an information processing apparatus, coordination information including authentication information to be used for authentication and an authentication method of a cloud service that the company provides to a user of the information processing apparatus in cooperation with the information processing apparatus; on a storage that pre-stores on a per authentication method basis of the cloud service an authentication application corresponding to the authentication method of the cloud service, start up an authentication application corresponding to an authentication method of a cloud service selected by the user from among the cloud services having received the coordination information; and by using the authentication application corresponding to the authentication method of the selected cloud service and the coordination information on the selected cloud service, perform control such that the information processing apparatus executes the cloud service.

### BRIEF DESCRIPTION OF THE DRAWINGS

Exemplary embodiment of the present disclosure will be described in detail based on the following figures, wherein:

FIG. 1 illustrates the configuration of an information processing system;

FIG. 2 illustrates an example of relationship of a cloud service;

FIG. 3 illustrates an example of the configuration of a cloud platform;

FIG. 4 illustrates an example of coordination information;

FIG. 5 illustrates an example of the approximate configuration of an electrical system of a cloud server;

FIG. 6 is a flowchart illustrating an example of the flow of a registration process;

FIG. 7 illustrates an example of a registration screen;

FIG. 8 is a flowchart illustrating an example of the flow of a service execution process;

FIG. 9 is a flowchart illustrating an example of the flow of a re-execution process; and

FIG. 10 is a flowchart illustrating an example of the flow of a registration process of coordination information executed using electronic signature.

### DETAILED DESCRIPTION

Exemplary embodiment is described below with reference to the drawings. Throughout the drawings, the same elements or the same operations are labeled with the same reference numeral and the explanation is not duplicated. Dimension ratios in the drawings are exaggerated for convenience of explanation and may thus be different from actual dimension ratios.

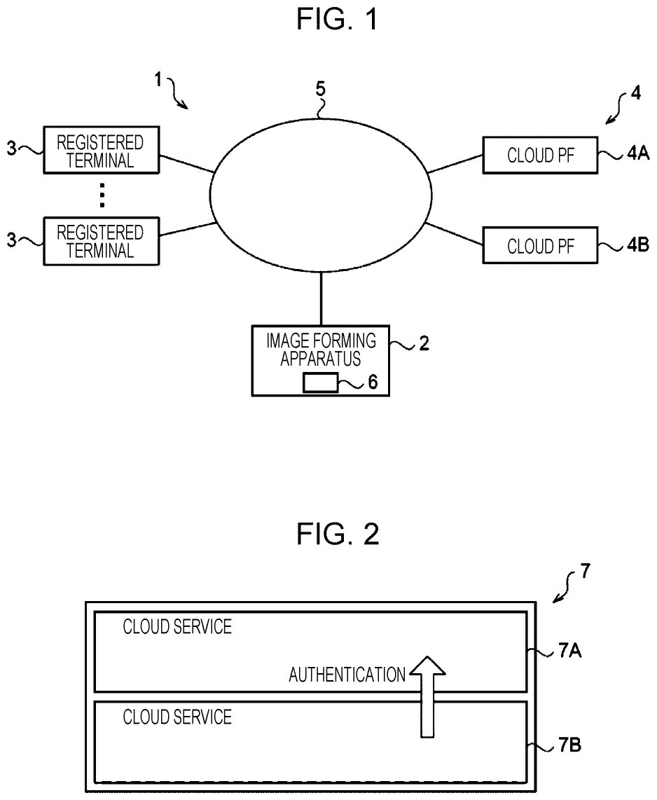

FIG. 1 illustrates the configuration example of an information processing system 1 of an exemplary embodiment of the disclosure. The information processing system 1 includes an image forming apparatus 2, registered terminal 3, and cloud platform 4. In the discussion that follows, the cloud platform 4 is referred to as the cloud PF 4. The platform is abbreviated as “PF.”

The image forming apparatus 2, registered terminal 3, and cloud PF 4 are connected to a communication network 5. The communication network 5 may be a network, such as a wide-area network (WAN).

Using a color material, such as toner, the image forming apparatus 2 forms on a paper sheet an image represented by image data specified by a user. The image forming apparatus 2 has multiple functions including an image forming function that forms an image on a paper sheet. The image forming apparatus 2 includes, for example, a scanner and has a copy function that optically reads image data of an original document through the scanner and then forms an image responsive to the read image data on a paper sheet. The image forming apparatus 2 also has a data transfer function that transmits image data specified by the user to an external service provided by an external apparatus connected to the communication network 5.

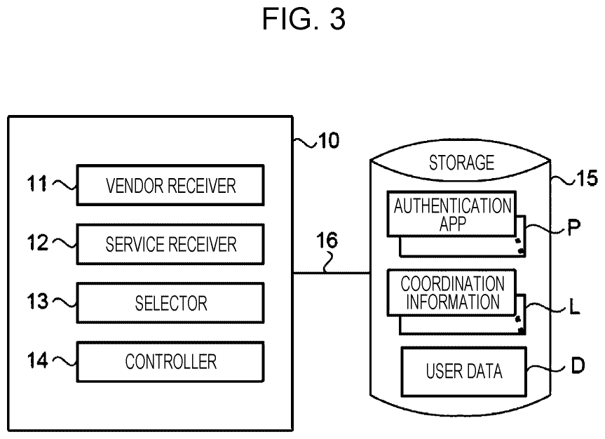

Data, such as image data, serving as a process target of the image forming apparatus 2 is referred to as “user data D” (see FIG. 3). The user data D is not limited to any particular data format and may be text data, for example.

Using the data transfer function on the user data D, the image forming apparatus 2 provides a coordination function using the external services.

The external services may be provided by a company different from the manufacturing company of the image forming apparatus 2. The external services include a variety of services. The external services provided by the company are not limited to any particular type. For example, the external services include a service of accounting process and enterprise resources planning (ERP) service that manages business information. Specifically, the manufacturing company of the image forming apparatus 2 does not necessarily provide users with services but coordinates with another company and thus provides a mechanism that provides users with a variety of services. Examples of the service that execute the accounting process as the external service with the image forming apparatus 2 may include reading a paper document of ledger with the image forming apparatus 2 and creating a PDF (registered trademark) electronic document file in accordance with the read image. The image forming apparatus 2 extracts character string information from the read image through an optical character recognizing function and transfers the created PDF document file and text data of character string information to an accounting process service that operates on a cloud server. The accounting process service thus executes the accounting process in the coordination process by receiving the PDF document file and text data of the character string information. PDF is the abbreviation for Portal Document Format (registered trademark).

The data transfer function of the image forming apparatus 2 for the user data D may be implemented, for example, using software. The software implementing the data transfer function is referred to as “coordination app 6.” App is the abbreviation for application. The data transfer function for the user data D may be implemented using hardware.

The coordination app 6 is developed by the manufacturing company of the image forming apparatus 2. The coordination app 6 is pre-loaded on the image forming apparatus 2 when the image forming apparatus 2 is shipped from the factory.

The external services may be provided by multiple companies. For convenience of explanation, the manufacturing company of the image forming apparatus 2 is referred to as a “manufacturer.” A company different from the manufacturing company of the image forming apparatus 2 is referred to as a “vendor.” Each vendor provides external services as cloud services such that the external services are easy for user to use through the communication network 5 by the user. An environment in which the external service provided by the vendor is available as the cloud service is referred to as cloud PF4A.

FIG. 1 illustrates the environment in which a single cloud PF4A is connected to the communication network 5. The number of clouds PF4A connected to the communication network 5 is not limited to one. The clouds PF4A as many as the number of external services available on the image forming apparatus 2 may be connected to the communication network 5.

The manufacturer may implement a coordination function with the external service using a cloud service. An environment in which the coordination function provided by the manufacturer is available as a cloud service is referred to as a cloud PF4B. The cloud PF4A and cloud PF4B are collectively referred to as “cloud PF4.”

The cloud service of the vendor implemented by the cloud PF4A is referred to as “cloud service 7A.” The cloud service of the manufacturer implemented by the cloud PF4B is referred to as “cloud service 7B.” When the cloud service 7A is not differentiated from the cloud service 7B, each service is occasionally referred to as a “cloud service 7.”

FIG. 2 illustrates an example of relationship of the cloud service 7. When the cloud service 7A is used from the cloud service 7B, authentication predetermined on each cloud service 7B is executed.

The number of clouds PF4B is not limited to one and the coordination function with the external service may be implemented using multiple clouds PF4B. According to the exemplary embodiment of the disclosure, a single cloud PF4B is connected to the communication network 5.

Referring to FIG. 1, one registered terminal 3 is installed on a per external service basis. The registered terminal 3 is installed by the vendor that provides a corresponding external service. In other words, the registered terminal 3 is operated by a person in charge of the vendor.

The person in charge of the vendor enters coordination information L (see FIG. 3) on the registered terminal 3. The coordination information L includes authentication information used for authentication and an authentication method of the cloud service 7A that the vendor provides to a user of the image forming apparatus 2 in cooperation with the image forming apparatus 2. Using authentication information registered by the registered terminal 3, the cloud service 7B executes an authentication process of the cloud service 7A specified by the user. If the cloud service 7A is successfully authenticated, the cloud service 7A and cloud service 7B are able to coordinate with each other.

FIG. 3 illustrates an example of the configuration of the cloud PF4B that executes the cloud service 7B. The cloud PF4B includes, for example, a cloud server 10 and storage 15. The cloud server 10 and storage 15 are connected to each other via a local-area network (LAN) 16.

The cloud server 10 includes a vendor receiver 11, service receiver 12, selector 13, and controller 14.

The vendor receiver 11 receives the coordination information L from the registered terminal 3 of the vendor via the communication network 5. The vendor receiver 11 stores the received coordination information L on the storage 15.

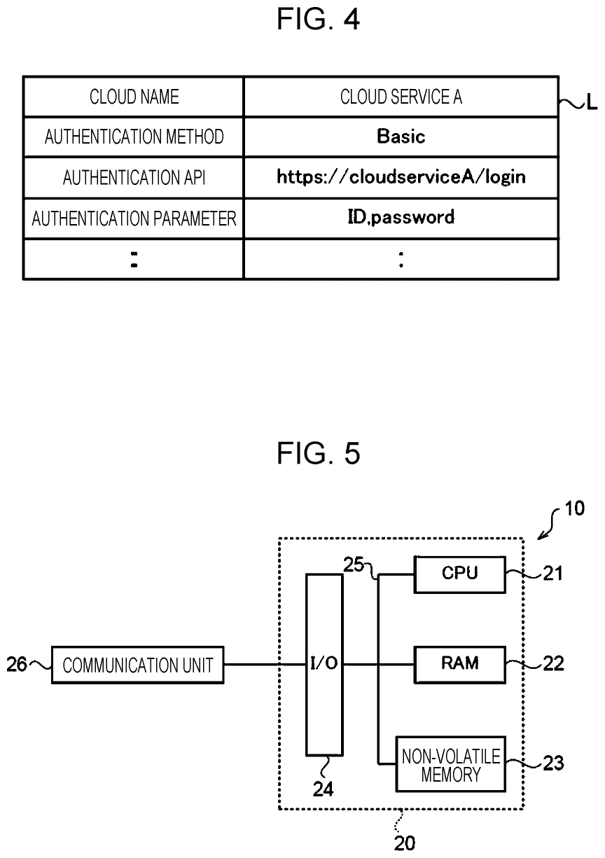

FIG. 4 illustrates an example of the coordination information L. The coordination information L includes, for example, a cloud name, authentication method, authentication API, and authentication parameter. API is the abbreviation for Application Programming Interface.

The cloud name is the name of the cloud service 7A that the vendor provides to the user of the image forming apparatus 2. The cloud service 7A and the coordination information L are associated with each other using the cloud name.

User authentication defined on each cloud service 7A is executed to execute the cloud service 7A. The authentication methods of the user authentication include Basic authentication, OAuth authentication, and Device Authorization Flow. The authentication method of the coordination information L is the authentication method used by the cloud service 7A represented by the cloud name.

The authentication API represents the uniform resource locator (URL) that is used to execute user authentication of the cloud service 7A represented by the cloud name. Specifically, the authentication API represents an interface used to connect to the cloud service 7A.

The authentication parameter is information that is used to execute user authentication of the cloud service 7A represented by the cloud name. The authentication parameter includes an identification (ID) and password, identifying an execution source of the cloud service 7A.

Note that the coordination information L may include the cloud name, authentication method, authentication API, and information excluding the authentication parameter. For example, the coordination information L may include the URL of the registered terminal 3 with the coordination information L registered, mail address assigned to the registered terminal 3, and other information.

The service receiver 12 illustrated in FIG. 3 receives the cloud name that is selected by the user on the image forming apparatus 2 via the communication network 5 and the user data D that is transmitted to the cloud service 7A represented by the cloud name. The service receiver 12 stores the received user data D on the storage 15. Note that the service receiver 12 may receive information other than the cloud name and user data D. For example, the service receiver 12 may receive the URL of the image forming apparatus 2 having transmitted the user data D and other information.

The storage 15 pre-stores the authentication application P (hereinafter referred to as authentication app P) that is prepared on a per authentication method basis. The authentication app P is an application developed by the manufacturer. One authentication app P corresponds to one authentication method. Each authentication app P executes an authentication procedure for the cloud service 7A in accordance with the corresponding authentication method.

The selector 13 selects, from the coordination information L stored on the storage 15, the coordination information L including the cloud name received by the service receiver 12. Further from the authentications app P stored on the storage 15, the selector 13 select the authentication app P corresponding to the authentication method included in the selected coordination information L and starts up the selected authentication app P.

Using the authentication app P and coordination information L, selected by the selector 13, the controller 14 executes control such that the cloud service 7A selected on the image forming apparatus 2 by the user may be executed. Specifically, the controller 14 notifies the authentication app P of the authentication API and authentication parameter included in the coordination information L selected by the selector 13. The controller 14 then instructs the authentication app P to execute user authentication using the notified the authentication API and authentication parameter. The authentication app P executes user authentication with the cloud service 7A in accordance with the authentication method corresponding to the authentication app P. In this way, the cloud service 7A that the user has specified on the image forming apparatus 2 via the cloud service 7B is executable. The controller 14 transmits the user data D to the cloud service 7A and then leaves the subsequent process to the cloud service 7A.

In the configuration illustrated in FIG. 3, the cloud server 10 and storage 15 are separate apparatuses but the cloud PF4B is not limited to such a configuration. For example, a storage in the cloud server 10 may be the storage 15.

The cloud server 10 executing the process described above may be implemented, for example, using a computer 20.

FIG. 5 illustrates an example of the approximate configuration of the electrical system of the cloud server 10 that is constructed using the computer 20.

The computer 20 forming the cloud server 10 includes a central processing unit (CPU) 21 serving as an example of a processor functioning as an element of the cloud server 10. The computer 20 also includes a random-access memory (RAM) 22 that serves as a temporary working area. The computer 20 also includes a non-volatile memory 23 and input-output interface (IF) 24. The CPU 21, RAM 22, non-volatile memory 23 and input-output IF 24 are interconnected to each other via a bus 25.

The non-volatile memory 23 is an example of the storage that continuously stores information even when power supplied to the non-volatile memory 23 is interrupted. The non-volatile memory 23 may be a semiconductor memory or a hard disk. The non-volatile memory 23 stores the information, such as the authentication app P, which is to be continuously stored even when power to the computer 20 is interrupted. In the following discussion, the non-volatile memory 23 is the storage 15.

The input-output IF 24 is connected to a communication unit 26, for example. The communication unit 26 is connected to the communication network 5 and supports a communication protocol that transmits information to and receives information from the image forming apparatus 2, registered terminal 3, and cloud PF4A, connected to the communication network 5.

The unit connected to the input-put IF 24 is not limited to the communication unit 26. A unit is selected depending on the function of the cloud server 10 and is then connected to the IF 24. For example, an input unit that receives an instruction from the user and notifies the CPU 21 of the instruction may be connected to the input-put IF 24. A display unit that displays, as an image, information processed by the CPU 21 may be connected to the input-put IF 24.

The registration process of the coordination information L is described below. The vendor that provides the cloud service 7A to the image forming apparatus 2 registers the coordination information L on the cloud server 10 before providing the cloud service 7A.

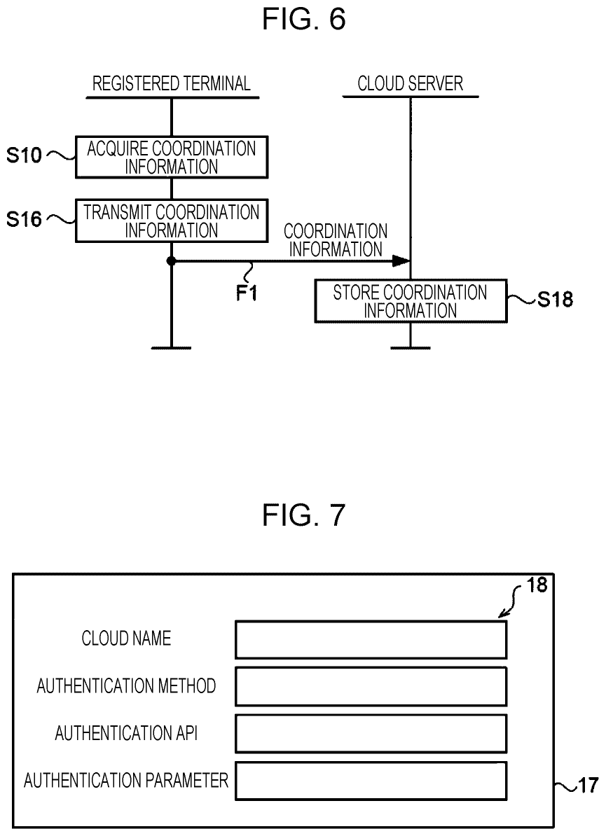

FIG. 6 is a flowchart illustrating an example of the flow of the registration process that the CPU 21 in the computer 20 forming the cloud server 10 executes when the coordination information L is received from the registered terminal 3.

An information processing program defining the registration process is pre-stored on, for example, the non-volatile memory 23 in the computer 20. The CPU 21 retrieves the information processing program from the non-volatile memory 23 and executes the registration process.

The coordination information L is input on the registration screen 17 displayed on the registered terminal 3.

FIG. 7 illustrates an example of the registration screen 17. The registration screen 17 includes, for example, text boxes 18 corresponding to the cloud name, authentication method, authentication API, and authentication parameter. The person in charge of the vendor respectively enters the cloud name, authentication method, authentication API, and authentication parameter in the corresponding text boxes 18. Even when information other than the cloud name, authentication method, authentication API, and authentication parameter is included in the coordination information L, the information is entered on the registration screen 17.

The person in charge of the vendor enters the coordination information L on the registration screen 17, and then the registered terminal 3 acquires the coordination information L entered on the registration screen 17 in step S10 in FIG. 6.

The registered terminal 3 transmits the acquired coordination information L to the cloud server 10 in step S16 (see F1).

The CPU 21 in the cloud server 10 having received the coordination information L stores the received coordination information L on the non-volatile memory 23 in step S18. The registration process illustrated in FIG. 6 is thus completed.

Each vendor enters the coordination information L on the cloud service 7A from the registered terminal 3 and then the coordination information L is stored on the non-volatile memory 23 on each cloud service 7A.

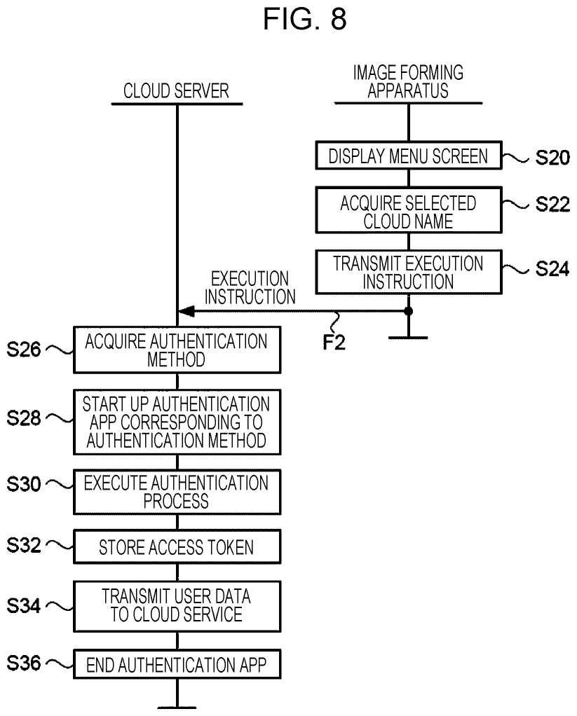

FIG. 8 is a flowchart illustrating an example of the flow of a service execution process that the CPU 21 executes when the user executes the cloud service 7A on the image forming apparatus 2. The CPU 21 retrieves a service execution program from the non-volatile memory 23 and executes the service execution process. Note that the user data D serving as a process target is present on the image forming apparatus 2 when the service execution process starts.

The image forming apparatus 2 displays a menu screen (not illustrated) on a display in step S20. The user selects, from a cloud list displayed on the menu screen, a cloud name of the cloud service 7A the user wants to execute. The cloud list lists the vendor cloud services 7A that are available using the image forming apparatus 2. The image forming apparatus 2 acquires the cloud name of each piece of coordination information L stored on the non-volatile memory 23 in the cloud server 10 and displays the acquired cloud names in the cloud list.

The image forming apparatus 2 acquires the cloud name selected by the user in step S22.

In step S24, the image forming apparatus 2 transmits to the cloud server 10 an execution instruction for the cloud service 7A represented by the cloud name selected by the user (see F2). The execution instruction includes, for example, the user data D, a device identifier pre-assigned to the image forming apparatus 2 and the selected cloud name. For example, the execution instruction may include a user identifier (ID), such as a mail address, uniquely identifying the user having selected the cloud name.

In step S26, the CPU 21 in the cloud server 10 having received the execution instruction references the cloud name included in the execution instruction. The CPU 21 acquires the authentication method by referencing the coordination information L stored on the non-volatile memory 23 and associated with the cloud name included in the execution instruction. Specifically, the CPU 21 acquires from the coordination information L the authentication method of the cloud service 7A represented by the cloud name included in the execution instruction.

In step S28, the CPU 21 starts up the authentication app P corresponding to the authentication method acquired in step S26.

In step S30, the CPU 21 notifies the authentication app P of the authentication API and authentication parameter included in the coordination information L associated with the cloud name included in the execution instruction. Upon receiving the authentication API and authentication parameter, the authentication app P executes, using the authentication parameter, the authentication process on the cloud service 7A specified by the authentication API in accordance with the authentication method of the authentication app P.

When the authentication process is successfully completed, the cloud service 7A is connected to the cloud service 7B. Specifically, the cloud service 7A specified by the user may be executable through the cloud service 7B from the image forming apparatus 2.

When the authentication process is successfully completed, the cloud service 7A may issue an access token. The access token is credentials that indicate that a connection source (the cloud server 10) of the cloud service 7A is a legitimate connection source that is permitted to connect to the cloud service 7A. Without executing the authentication process, the cloud server 10 may be connected to the successfully authenticated cloud service 7A using the access token. The transmission destination of the access token is the same URL as the authentication API.

In step S32, the CPU 21 stores on the non-volatile memory 23 the access token in association with the cloud name serving as an issuer of the access token. An expiration date is set on each access token. If the access token is expired, the CPU 21 acquires an access token by executing the authentication process again using the authentication parameter.

In step S34, the CPU 21 transmits the user data D included in the execution instruction to the connected cloud service 7A. Service using the user data D may be available on the cloud service 7A. When data addressed to the image forming apparatus 2 is received from the cloud service 7A, the CPU 21 transfers the data to the image forming apparatus 2 in accordance with the device identifier included in the execution instruction.

In step S36, the CPU 21 ends the authentication app P started up in step S28. The service execution process illustrated in FIG. 8 is thus completed.

In the information processing system 1 of the embodiment of the disclosure, the vendor may cause the image forming apparatus 2 and cloud service 7A to coordinate with each other by simply registering the coordination information L on the cloud server 10 from the registered terminal 3. Specifically, the vendor is free from developing their own application that causes the cloud service 7A of the vendor to be used on the image forming apparatus 2, and the vendor may allow the user to execute the cloud service 7A on the image forming apparatus 2.

### Correction of Coordination Information

A contract partner and the configuration of the cloud PF4A that implements the cloud service 7A with the coordination information L registered on the cloud server 10 are changed due to the vendor's convenience. In such a case, the coordination information L may also be changed. The person in charge of the vendor enters new coordination information on the registered terminal 3 and corrects the coordination information L registered on the cloud server 10.

However, the coordination information L may not be corrected depending on the person in charge of the vendor. The process of the information processing system 1 with the coordination information L not corrected is described below.

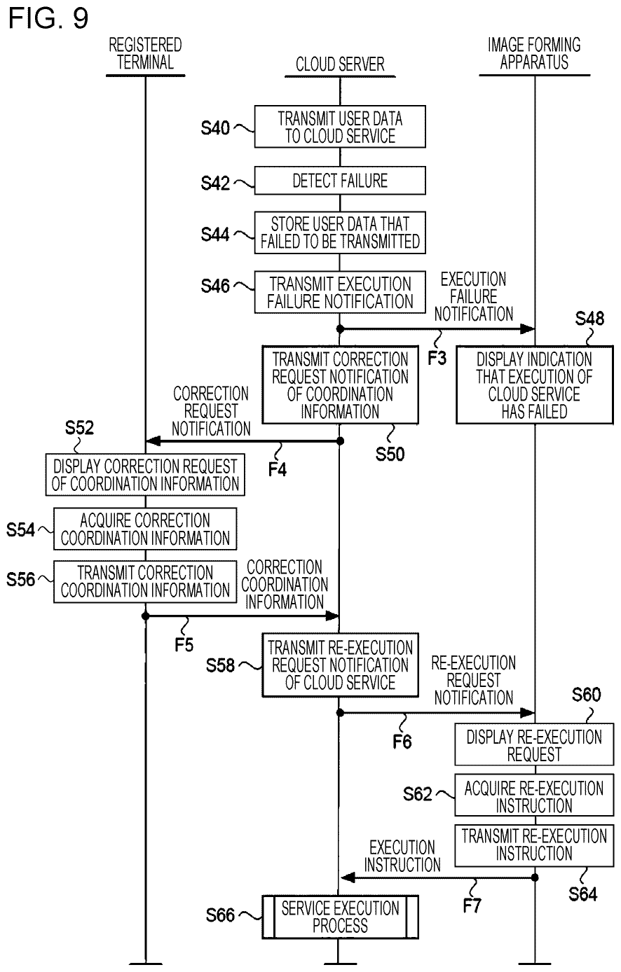

FIG. 9 is a flowchart illustrating an example of the flow of a re-execution process executed by the CPU 21 when the user data D is transmitted using the access token to the cloud service 7A with the coordination information L not corrected. The CPU 21 retrieves an information processing program from the non-volatile memory 23 and then executes the re-execution process. Note that the service execution process has been executed at least once on the cloud service 7A serving as the transmission destination of the user data D and the access token has been acquired.

In step S40, the CPU 21 acquires the access token of the cloud service 7A stored on the non-volatile memory 23 in step S32 in FIG. 8 and specified by the user. Using the acquired access token, the CPU 21 transmits the user data D to the cloud service 7A specified by the user. If a correct authentication API is not reflected on the coordination information L, the CPU 21 fails to transmit the user data D. In step S42 in FIG. 9, the CPU 21 thus detects the failure to execute the cloud service 7A specified by the user.

In step S44, the CPU 21 stores on the non-volatile memory 23 the user data D that is attempted to be transmitted to the cloud service 7A that fails to be executed. In this case, the CPU 21 stores on the non-volatile memory 23 the user data D in association with a user ID of the user who has provided an instruction to execute the cloud service 7A.

In step S46, the CPU 21 transmits an execution failure notification notifying of the execution failure of the specified cloud service 7A to the image forming apparatus 2 serving as a sender of the execution instruction (see F3).

In step S48, the image forming apparatus 2 having received the execution failure notification displays on a display an indication indicating that the selected cloud service 7A has failed to be executed. In this way, the user recognizes the failure of the execution of the specified cloud service 7A. Note that the CPU 21 may transmit the execution failure notification to the mail address of the user. The mail address of the user may be included in the execution instruction.

The failure to execute the cloud service 7A with usage record may signify that correct information is not reflected on the coordination information L. In step S50, the CPU 21 transmits, to the registered terminal 3 of the vendor providing the cloud service 7A that has failed to be executed, a correction request notification requesting the registered terminal 3 to correct the coordination information L (see F4). The correction request notification is an example of a first request notification in the exemplary embodiment of the disclosure.

In step S52, the registered terminal 3 having received the correction request notification displays a correction request prompting the display to correct the coordination information L. The person in charge of the vendor having confirmed the correction request enters the corrected coordination information L on the registration screen 17 illustrated in FIG. 7.

In step S54 illustrated in FIG. 9, the registered terminal 3 thus acquires the corrected coordination information L (hereinafter referred to as “correction coordination information L”).

In step S56, the registered terminal 3 transmits the correction coordination information L to the cloud server 10 (see F5).

In step S58, the CPU 21 in the cloud server 10 having received the correction coordination information L substitutes the acquired correction coordination information L for the old coordination information L corresponding to the cloud service 7A having failed to be executed. The CPU 21 then transmits a re-execution request notification to the image forming apparatus 2 having failed to execute the cloud service 7A (see F6). Note that the CPU 21 may transmit a re-execution request notification to the mail address of the user having selected the cloud service 7A having failed to be executed. The re-execution request notification may be a second request notification that requests the user to re-execute the cloud service 7A having failed to be executed.

In step S60, the image forming apparatus 2 having received the re-execution request notification displays on the display a re-execution request prompting the user to re-execute the cloud service 7A. The user having confirmed the re-execution request selects again on the menu screen the cloud name of the cloud service 7A having failed to be executed.

In step S62, the image forming apparatus 2 acquires a re-execution instruction of the cloud service 7A.

The image forming apparatus 2 transmits the acquired re-execution instruction to the cloud server 10 in step S64 (see F7). Note that the user data D included in the execution instruction is not included in the re-execution instruction. The re-execution instruction includes, for example, a device identifier pre-assigned to the image forming apparatus 2 and selected cloud name.

The CPU 21 in the cloud server 10 having received the re-execution instruction executes operations in step S26 and subsequent steps in the service execution process illustrated in FIG. 8 in step S66. The CPU 21 may transmit the user data D to the cloud service 7A in order to execute the authentication process using the correction coordination information L. In this case, the user data D to be transmitted to the cloud service 7A in step S34 illustrated in FIG. 8 is the user data D stored on the non-volatile memory 23 in step S44 in FIG. 9. The re-execution process illustrated in FIG. 9 is thus completed.

In response to the reception of the correction coordination information L, the cloud server 10 may execute the service execution process in step S66 without transmitting the re-execution request notification to the image forming apparatus 2.

The information processing system 1 of the exemplary embodiment of the disclosure uses the user data D stored on the cloud service 7B when the cloud service 7A is re-executed. An operation to re-generate the user data D on the image forming apparatus 2 may thus be skipped. Since the vendor is prompted to correct the coordination information L, the use of the cloud service 7A may be restarted earlier.

### Electronic Signature of Coordination Information

As described above, the information processing system 1 of the exemplary embodiment of the disclosure causes the image forming apparatus 2 and cloud service 7A to coordinate with each other using the coordination information L registered by the vendor. If an unscrupulous person impersonates the person in charge of the vendor and edits the coordination information L, the cloud server 10 may be guided to a cloud service 7A different from the cloud service 7A specified by the user.

The cloud server 10 may thus confirm whether the received coordination information L is the coordination information L input by the authentic vendor. For example, the cloud server 10 may verify authenticity of the coordination information L using electronic signature.

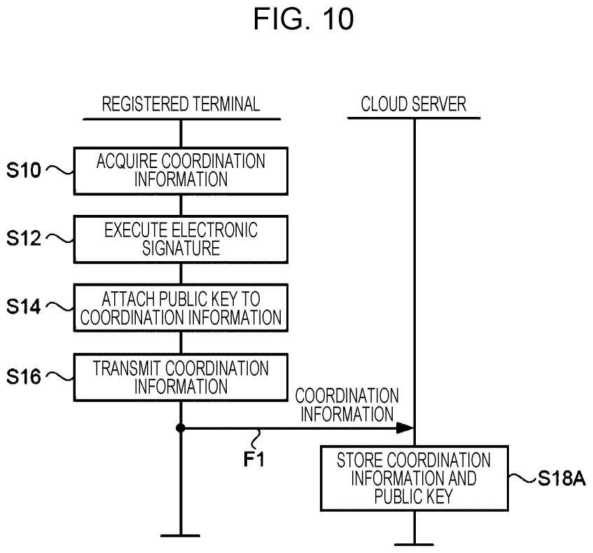

FIG. 10 is a flowchart illustrating an example of the flow of a registration process of the coordination information L executed using electronic signature. The registration process illustrated in FIG. 10 is different from the registration process illustrated in FIG. 6 in that steps S12 and S14 are added and step S18A is substituted for step S18 as illustrated in FIG. 10.

The registered terminal 3 proceeds to step S12 after acquiring the coordination information L in step S10 as illustrated in FIG. 10.

In step S12, the registered terminal 3 encrypts a hash value of the coordination information L acquired in step S10 with a private key and thus executes electronic signature on the coordination information L. The coordination information L having undergone electronic signature is referred to as “signed coordination information L.”

In step S14, the registered terminal 3 attaches to the coordination information L a public key paired with the private key used for electronic signature.

In step S16, the registered terminal 3 transmits the signed coordination information L and public key to the cloud server 10 (see F1).

The CPU 21 in the cloud server 10 having received the signed coordination information L stores the signed coordination information L on the non-volatile memory 23 in step S18A. The registration process illustrated in FIG. 10 is thus completed.

Referring to FIG. 8, the CPU 21 executes operations in step S26 and subsequent steps after receiving the execution instruction from the image forming apparatus 2. The CPU 21 thus verifies authenticity of the coordination information L before acquiring the authentication method from the coordination information L in step S26.

Specifically, the CPU 21 decrypts the electronic signature of the coordination information L with the public key attached to the coordination information L. The decrypted information is the hash value of the coordination information L calculated by the registered terminal 3. On the other hand, the CPU 21 calculates a hash value of the coordination information L and compares the hash value calculated by the CPU 21 with the decrypted hash value. If the hash values match, the CPU 21 determines that the referenced coordination information L is the coordination information L that the authentic vendor has registered. The CPU 21 thus continuously executes operations in step S26 and subsequent steps. On the other hand, if the hash values are different from each other, the CPU 21 determines that the referenced coordination information L is not the coordination information L that the authentic vendor has registered. The CPU 21 simply ends the service execution process illustrated in FIG. 8 without executing the operations in step S26 and subsequent steps.

Even if the authentic vendor has executed the first registration process on the coordination information L, the coordination information L may be later corrected by an unscrupulous person. When new coordination information L is registered on the cloud service 7A corresponding to the authentic coordination information L, authenticity of the coordination information L may be verified. Specifically, each time new coordination information L with electronic signature is received, the CPU 21 may verify authenticity of the new coordination information L in the method described above using a public key attached to the new coordination information L.

The CPU 21 may further verify authenticity of the coordination information L by comparing public keys. The verification method of the authenticity of the coordination information L described below is executed by comparing public keys when the correction coordination information L is received with reference to F5 illustrated in FIG. 9. The verification method is executed assuming that the correction coordination information L is electronically signed. The correction coordination information L with electronic signature is referred to as “signed correction coordination information L.”

The CPU 21 compares the public key of the signed coordination information L stored on the non-volatile memory 23 with the public key of the signed correction coordination information L that has been newly acquired. The public key of the signed coordination information L is an example of a first public key of the exemplary embodiment of the disclosure. The public key of the signed correction coordination information L is an example of a second public key of the exemplary embodiment of the disclosure.

Authenticity of the signed coordination information L stored on the non-volatile memory 23 is guaranteed. If the public key of the signed coordination information L is identical to the public key of the signed correction coordination information L, the signed correction coordination information L is considered to be sent by the same vendor having usage record. In other words, the signed correction coordination information L is considered to be sent by the authentic vendor. The CPU 21 thus updates the signed coordination information L stored on the non-volatile memory 23 with the signed correction coordination information L that has been newly acquired.

If the public key of the signed coordination information L is different from the public key of the signed correction coordination information L, the signed correction coordination information L is considered to be sent by an unscrupulous person. The CPU 21 thus quits the process for the subsequent steps without updating the signed coordination information L stored on the non-volatile memory 23 with the signed correction coordination information L that has been newly acquired.

In the process described above, the registered terminal 3 attaches public keys to all the signed coordination information L but may attach a public key to only the signed coordination information L that is registered first on the cloud server 10. Specifically, the registered terminal 3 attaches no public key to the signed correction coordination information L.

In such a case, using the public key attached to the signed coordination information L received first from the registered terminal 3, the CPU 21 may inspect the hash value of the signed correction coordination information L in the method described above.

An example of the information processing system 1 has been described with reference to the exemplary embodiment. The information processing system 1 is not limited to the exemplary embodiment. A variety of changes and modifications may be made without departing from the scope of the disclosure. An exemplary embodiment with changes and modifications falls within the scope of the disclosure. For example, the order of operations in each of the processes described with reference to FIGS. 6 and 8 through 10 may be changed without departing from the scope of the disclosure.

In the exemplary embodiment described above, each of the processes is implemented using software. Alternatively, each of the processes illustrated in the corresponding flowcharts may be implemented using hardware. In such a case, each process may be sped up in comparison with the case in which each process is implemented using software.

In the exemplary embodiment, the processes are executed by any computer. The computer may execute the processes by using a processor serving as hardware, a program serving as software, or combination of these. In this case, the processor is configured to execute the processes in the exemplary embodiment in cooperation with the program and may function as a unit or a means in the exemplary embodiment. The order in which the processor executes the processes is not limited to the described order and may be changed appropriately. The computer may be a general-purpose computer, an application specific computer, a workstation, or another system capable of executing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program may be supplied as a program product.

The information processing system 1 may download the information processing program from an external apparatus via the communication unit 26 and store the downloaded information processing program on the non-volatile memory 23.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

1

An information processing system including:
a processor configured to:
receive from an information terminal of a company different from a manufacturing company of an information processing apparatus, coordination information including authentication information to be used for authentication and an authentication method of a cloud service that the company provides to a user of the information processing apparatus in cooperation with the information processing apparatus;
on a storage that pre-stores on a per authentication method basis of the cloud service an authentication application corresponding to the authentication method of the cloud service, start up an authentication application corresponding to an authentication method of a cloud service selected by the user from among the cloud services having received the coordination information; and
by using the authentication application corresponding to the authentication method of the selected cloud service and the coordination information on the selected cloud service, perform control such that the information processing apparatus executes the cloud service.
   2

In the information processing system according to (((1))), the processor is configured to, when the information processing apparatus fails to execute the cloud service having a usage record, output a first request notification that requests to correct the coordination information a registered terminal that is pre-registered by the company that provides the cloud service that has failed to be executed.

3

In the information processing system according to (((2))), the processor is configured to, when the coordination information that is corrected is received from the information terminal of the company that provides the cloud service that has failed to be executed, cause the information processing apparatus to output a second request notification that requests the user to re-execute the cloud service that has failed to be executed.

4

In the information processing system according to (((3))), the processor is configured to, when the user re-executes in response to the second request notification the cloud service that has failed to be executed, re-transmit, to the cloud service having failed to be executed, data that is stored on the storage and is attempted to be transmitted to the cloud service having failed to be executed.

5

In the information processing system according to (((2))), the processor is configured to cause the information processing apparatus to output information indicating that the selected cloud service is inexecutable.

6

In the information processing system according to one of (((1))) through (((5))), the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the coordination information received together with the second public key if the first public key is identical to the second public key.
   7

In the information processing system according to one of (((1))) through (((5))), the processor is configured to:
when the coordination information is registered first by the company, receive from the information terminal of the company the coordination information and a public key of electronic signature that the company has made on the coordination information; and
when new coordination information is registered on the cloud service with which the coordination information has been associated, inspect electronic signature of the new coordination information using the public key of the coordination information associated with the cloud service and update the coordination information associated with the cloud service in accordance with the new coordination information if a sender of the new coordination information is identical to a sender of the coordination information.
   8

An information processing program causing a computer to execute a process for processing information, the process comprising:
receiving from an information terminal of a company different from a manufacturing company of an information processing apparatus, coordination information including authentication information to be used for authentication and an authentication method of a cloud service that the company provides to a user of the information processing apparatus in cooperation with the information processing apparatus;
on a storage that, before the coordination information is received, pre-stores on a per authentication method basis of the cloud service an authentication application corresponding to the authentication method of the cloud service, starting up an authentication application corresponding to an authentication method of a cloud service selected by the user from among the cloud services having received the coordination information; and
by using the authentication application corresponding to the authentication method of the selected cloud service and the coordination information on the selected cloud service, performing control such that the information processing apparatus executes the cloud service.

What is claimed is:

1. An information processing system comprising:
a processor configured to:
receive from an information terminal of a company different from a manufacturing company of an information processing apparatus, coordination information including authentication information to be used for authentication and an authentication method of a cloud service that the company provides to a user of the information processing apparatus in cooperation with the information processing apparatus;
on a storage that pre-stores on a per authentication method basis of the cloud service an authentication application corresponding to the authentication method of the cloud service, start up an authentication application corresponding to an authentication method of a cloud service selected by the user from among the cloud services having received the coordination information; and
by using the authentication application corresponding to the authentication method of the selected cloud service and the coordination information on the selected cloud service, perform control such that the information processing apparatus executes the cloud service.

2. The information processing system according to claim 1, wherein the processor is configured to, when the information processing apparatus fails to execute the cloud service having a usage record, output a first request notification that requests to correct the coordination information a registered terminal that is pre-registered by the company that provides the cloud service that has failed to be executed.

3. The information processing system according to claim 2, wherein the processor is configured to, when the coordination information that is corrected is received from the information terminal of the company that provides the cloud service that has failed to be executed, cause the information processing apparatus to output a second request notification that requests the user to re-execute the cloud service that has failed to be executed.

4. The information processing system according to claim 3, wherein the processor is configured to, when the user re-executes in response to the second request notification the cloud service that has failed to be executed, re-transmit, to the cloud service having failed to be executed, data that is stored on the storage and is attempted to be transmitted to the cloud service having failed to be executed.

5. The information processing system according to claim 2, wherein the processor is configured to cause the information processing apparatus to output information indicating that the selected cloud service is inexecutable.

6. The information processing system according to claim 1, wherein the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the new coordination information received together with the second public key if the first public key is identical to the second public key.

7. The information processing system according to claim 2, wherein the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the new coordination information received together with the second public key if the first public key is identical to the second public key.

8. The information processing system according to claim 3, wherein the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the new coordination information received together with the second public key if the first public key is identical to the second public key.

9. The information processing system according to claim 4, wherein the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the new coordination information received together with the second public key if the first public key is identical to the second public key.

10. The information processing system according to claim 5, wherein the processor is configured to:
each time the coordination information is registered by the company, receive from the information terminal of the company the coordination information and a public key of electronic signature that the company has made on the coordination information; and
when new coordination information is registered on the cloud service with which the coordination information has been associated, compare a first public key of the coordination information associated with the cloud service with a second public key of the new coordination information corresponding to the cloud service and update the coordination information associated with the cloud service in accordance with the new coordination information received together with the second public key if the first public key is identical to the second public key.

11. A non-transitory computer readable medium storing a program causing a computer to execute a process for processing information, the process comprising:
receiving from an information terminal of a company different from a manufacturing company of an information processing apparatus, coordination information including authentication information to be used for authentication and an authentication method of a cloud service that the company provides to a user of the information processing apparatus in cooperation with the information processing apparatus;
on a storage that, before the coordination information is received, pre-stores on a per authentication method basis of the cloud service an authentication application corresponding to the authentication method of the cloud service, starting up an authentication application corresponding to an authentication method of a cloud service selected by the user from among the cloud services having received the coordination information; and
by using the authentication application corresponding to the authentication method of the selected cloud service and the coordination information on the selected cloud service, performing control such that the information processing apparatus executes the cloud service.

12. An information processing method comprising:
receiving from an information terminal of a company different from a manufacturing company of an information processing apparatus, coordination information including authentication information to be used for authentication and an authentication method of a cloud service that the company provides to a user of the information processing apparatus in cooperation with the information processing apparatus;
on a storage that, before the coordination information is received, pre-stores on a per authentication method basis of the cloud service an authentication application corresponding to the authentication method of the cloud service, starting up an authentication application corresponding to an authentication method of a cloud service selected by the user from among the cloud services having received the coordination information; and
by using the authentication application corresponding to the authentication method of the selected cloud service and the coordination information on the selected cloud service, performing control such that the information processing apparatus executes the cloud service.
